(19) United States
(12) Patent Application Publication
(10) Pub. No.: US 2023/0355362 A1
(43) Pub. Date: Nov. 9, 2023

(54) AUTOMATIC CREATION OF A VIRTUAL MODEL OF AT LEAST A PART OF AN ORTHODONTIC APPLIANCE

(71) Applicant: Hirsch Dynamics Holding AG, Wollerau (CH)

(72) Inventor: Markus HIRSCH, Wollerau (CH)

(73) Assignee: Hirsch Dynamics Holding AG, Wollerau (CH)

(21) Appl. No.: 18/212,763

(22) Filed: Jun. 22, 2023

Related U.S. Application Data
(63) Continuation of application No. PCT/EP2020/087817, filed on Dec. 23, 2020.

(51) Int. Cl. A61C 13/00; G06T 17/00

(52) U.S. Cl. CPC A61C 13/0019; G06T 17/00

(57) ABSTRACT

A computer-implemented method and a system create a virtual model of at least a part of an orthodontic appliance. A process for manufacturing at least a part of an orthodontic appliance is described. A device formed by an orthodontic appliance and at least one strut is described.

### CROSS REFERENCE TO RELATED APPLICATIONS

This application is a continuation of and Applicant claims priority under 35 U.S.C. § 120 of International Application No. PCT/EP2020/087817 filed on Dec. 23, 2020. The international application under PCT article 21(2) was published in English. The disclosure of the aforesaid International Application is incorporated by reference.

### TECHNICAL FIELD

In a first aspect, the present invention relates to a (computer-implemented) method and a system for creating a virtual model of at least a part of an orthodontic appliance. In a second aspect, the present invention relates to a process for manufacturing at least the part of the orthodontic appliance. In a third aspect, the present invention relates to a device comprising an orthodontic appliance.

### BACKGROUND

For orthodontic appliances it is essential to adapt the orthodontic appliance according to the geometry and form of teeth of a patient's dentition to ensure comfort during wearing and enhance a treatment quality by a suitable fit of the orthodontic appliance on the dentition. Conventional orthodontic appliances and in particular processes regarding the manufacturing of these require trained medical technical staff which create the orthodontic appliances in a cumbersome and tedious procedure, whereby it is difficult to guarantee high precision. Furthermore, a high amount of time resources is needed and to overcome production tolerances to achieve the required quality of the orthodontic appliance—e.g. in supplementary steps with intermediate models—cost expensive devices are required as well.

An orthodontic appliance and a process of manufacturing the orthodontic appliance is already known from U.S. Pat. No. 4,516,938 A, whereby a lingual retainer is attached to a dentition and follows the curvature of a dental arch. The lingual retainer requires elastic materials—given by various materials of different sheets of the lingual retainer—which is crucial for the bonding between the lingual retainer and the teeth of the patient without a loss of bonding during treatment. In addition, a high amount of adhesive is required to take into account the complex geometry of the teeth with respect to a suitable bonding since the lingual retainer is manufactured by sheet material.

US 2019/0328491 A1 discloses a process for manufacturing an orthodontic appliance, whereby a 3D-model for a CAD software is created by use of intraoral scans, impressions, tomography or x-rays of a patient's dentition. By means of the 3D-model a model of a lingual retainer is manufactured on basis of the 3D-model, whereby the model of the lingual retainer is 3D-printed for instance to match a curvature of a dental arch. However, a correspondence of the lingual retainer and the dentition—in particular with each individual tooth to which the lingual retainer is to be bonded—depends on the qualification of the trained medical technical staff. This procedure is cumbersome, tedious, costly and time consuming as well as insufficient with respect to high demands as an optimal bonding between teeth (in particular with complex geometries of a specific tooth) and the orthodontic appliance. A virtual model of the lingual retainer is created by use of a CAD software. The degree of matching between the bonding area of the orthodontic appliance and the bonding surface of the teeth depends on the skill of a human operator of the CAD program and is time consuming.

What is needed is a method and system which are able to create a virtual model of at least a part of an orthodontic appliance in a more reliable and faster way, a computer program to cause a computer to carry out such a method or to embody such a system and a process which is able to manufacture an orthodontic appliance faster, more cost-efficient and more reliable than the methods and systems of the prior art as well as a computer-readable medium and a data carrier signal.

### SUMMARY OF INVENTION

It is an object of the invention to provide a method according to claim 1 and a system according to claim 9 which are able to create a virtual model of at least a part of an orthodontic appliance in a more reliable and faster way.

It is another object of the invention to provide a process which is able to manufacture at least a part of an orthodontic appliance faster, more cost-efficient and more reliable than the processes of the prior art.

Still other objects and advantages of the invention will in part be obvious and will in part be apparent from the specification and drawings.

One object of the disclosure relates to a method according to claim 1 and a system according to claim 9 which are able to create a virtual model of at least a part of an orthodontic appliance in a more reliable and faster way than in the prior art due to the use of at least one artificial neuronal network (in the following called in short: ANN) to create the virtual model of at least the part of the orthodontic appliance. This makes the inventive method and system independent of a human operator's skill and allows for a faster creation of the virtual model.

Another object of the disclosure relates to a process according to claim 17 which is able to manufacture at least a part of the orthodontic appliance faster, more cost-efficient and more reliable than the processes of the prior art.

Yet another object of the disclosure relates to a computer program according to claim 19 which, when the program is executed by a computer, causes the computer to carry out the method of claim 1 or any claim dependent thereon or to be configured as a system according to claim 9 or any claim dependent thereon.

Still another object of the disclosure relates to a computer-readable medium comprising instructions which, when executed by a computer, causes the computer to carry out the method of claim 1 or any claim dependent thereon or to be configured as a system according to claim 9 or any claim dependent thereon.

Still another object of the disclosure relates to a data carrier signal carrying: at least one virtual model created by a method of at least one of claim 1 to claim 8 or by a system according to at least one of claim 9 to claim 16 and/or the computer program of claim 19.

Still another object of the disclosure relates to a device according to claim 22 comprising: an orthodontic appliance, in particular manufactured by a process according to claim 17 or claim 18, which is adapted to be bonded or attached to a plurality of teeth and at least one strut wherein the at least one strut is connected to at least two different areas of the orthodontic appliance.

Hence, the device enables to manufacture the orthodontic appliance faster as distortions—e.g. due to temperature effects—are prevented within the manufacturing process as the at least one strut can be capable of increasing a mechanic stability of the orthodontic appliance during manufacturing. Furthermore, the at least one strut can be used to simplify an attaching and/or bonding of the orthodontic appliance to a patient's dentition. A location of an connecting point of the at least one (if applicable pre-defined by a template for instance) strut with the orthodontic appliance can be pre-defined, defined by a human operator in dependence on the virtual model of at least the part of the orthodontic appliance and/or automatically defined by the artificial neuronal network on basis of the virtual model of at least the part of the orthodontic appliance. The at least one strut can be removed in general before, during and/or after attaching the orthodontic appliance to the dentition.

Embodiments of the invention are defined in the dependent claims.

### DESCRIPTION OF EMBODIMENTS

A computing device suitable for the system can be chosen as is known in the prior art. It can comprise, e.g., one or more CPUs according to the art and a digital memory for saving all data for operation of the system. The term CPU encompasses any processor which performs operations on some data such as a central processing unit of a system, a co-processor, a Graphics Processing Unit, a Vision Processing Unit, a Tensor Processing Unit, an FPGA, an ASIC, a Neural Processing Unit, . . .

Artificial neuronal networks can be of any type as known in the art (such as a MfNN, RNN, LSTM, . . . ). An ANN comprises a plurality of artificial neurons. Each artificial neuron (in the following in short: “neuron”) has at least one (usually a plurality of) synapse for obtaining a signal and at least one axon for sending a signal (in some embodiments a single axon can have a plurality of branchings). Usually, each neuron obtains a plurality of signals from other neurons or from an input interface of the neuronal network via a plurality of synapses and sends a single signal to a plurality of other neurons or to an output interface of the neuronal network. A neuron body is arranged between the synapse(s) and the axon(s) and comprises at least an integration function (according to the art) for integrating the obtained signals and an activation function (according to the art) to decide whether a signal is to be sent by this neuron in reaction to the obtained signals. Any activation function of the art can be used such as a step-function, a sigmoid function, . . .

As is known in the art, the signals obtained via the synapses can be weighted by weight factors (synaptic weights). Individual weight factors can be provided by a weight storage. The weights can be determined as known in the art, e.g., during a training phase by modifying a pre-given set of weights such that a desired result is given by the ANN with a required accuracy. Other known techniques could be used.

As is known in the art, input signals and weights and output signals do not have to be in the format of scalars but can be defined as vectors or higher-dimensional tensors.

The term “real time” is defined pursuant to the norm DIN ISO/IEC 2382 as the operation of a computing system in which programs for processing data are always ready for operation in such a way that the processing results are available within a predetermined period of time. In particular the system for creating the virtual model can make use of real time operations, whereby time lags—for instance caused by a human's operation to create a virtual model by hand—can be prevented and time lags are limited to the usual time transmitting lags and operation lags that are in general negligible with respect to a human interacting within a software.

The computer-implemented method for creating a virtual model of at least a part of an orthodontic appliance, can comprise at least the following steps:
providing a virtual tooth model representing at least a lingual part and/or a labial part of a mandible and/or maxilla of a dentition of a patient, the virtual tooth model modeling at least a labial surface and/or a lingual surface of the patient's teeth to which the orthodontic appliance is to be bonded and/or attached
accepting, as input, a bonding area and/or an attaching area of the labial surface and/or the lingual surface of the virtual tooth model to which the orthodontic appliance is to be bonded and/or attached or, determining a bonding area and/or an attaching area of the labial surface and/or the lingual surface of the virtual tooth model to which the orthodontic appliance is to be bonded and/or attached
using at least one artificial neuronal network to create, on basis of said bonding area and/or attaching area of the virtual tooth model, at least the virtual model of at least the part of the orthodontic appliance, the virtual model of at least the part of the orthodontic appliance having a bonding surface and/or attaching surface which is modeled in such a way that said bonding surface which is modeled in such a way that said bonding surface and/or attaching surface matches the bonding area and/or attaching area of the virtual tooth model

To determine a bonding area and/or an attaching area is connected to the task to identify a location on which at least a part of the orthodontic appliance shall be positioned. To create a bonding surface and/or attaching surface is connected to the task to define the explizit geometry of at least part of the orthodontic appliance by the ANN—e.g. by use of negative surfaces with respect to the geometry of the virtual tooth model.

The system for creating a virtual model of at least a part of an orthodontic appliance, can comprise at least:
at least one input configured to receive a virtual tooth model representing at least a lingual part and/or a labial part of a mandible and/or maxilla of a dentition of a patient, the virtual tooth model modeling at least a labial surface and/or a lingual surface of the patient's teeth to which the orthodontic appliance is to be bonded and/or attached
at least one computing device which is configured to execute at least one artificial neuronal network which is trained to
   accept, as input, a bonding area and/or an attaching area of the labial surface and/or the lingual surface of the virtual tooth model to which the orthodontic appliance is to be bonded and/or attached or, determine a bonding area and/or an attaching area of the labial surface and/or the lingual surface of the virtual tooth model to which the orthodontic appliance is to be bonded an/or attached
   create, on basis of said bonding area and/or attaching area of the virtual tooth model, the virtual model of at least the part of the orthodontic appliance, the virtual model of at least the part of the orthodontic appliance having a bonding surface and/or attaching surface which is modeled in such a way that said bonding surface and/or attaching surface matches the bonding area and/or attaching area of the virtual tooth model

The method and system allow a very fast creation of the virtual model of at least a part of the orthodontic appliance and/or of a complete orthodontic appliance, preferably in real time.

The virtual model of at least part of the orthodontic appliance can be used in a process to manufacture a physical embodiment of the bonding part of the orthodontic appliance or the complete orthodontic appliance, preferably at the side of a user (e.g., a dentist or orthodontist) of the method and system provided there is a manufacturing device for manufacturing a physical embodiment of at least the bonding part (which is crucial as it shall correspond to the orthodontic condition to a high extent) provided at the side. If the user has a physical embodiment of a pre-defined part of the orthodontic appliance at hand, the user can e.g. mechanically combine the pre-defined part and the bonding part of the orthodontic appliance to build the complete orthodontic appliance, whereby it is particularly preferred provided that the artificial neuronal network creates the complete orthodontic appliance on its own to reduce time and costs.

It should be noted that data used as input for the method and system can represent a virtual tooth model of an individual tooth in isolation (that is to be combined with another virtual tooth model of another individual tooth or at least a part of it) or can represent a virtual model of a plurality of teeth (forming, e.g., at least a part of a dental arch) . If a plurality of virtual models of teeth is provided as input and the individual teeth are not already markep up as such in the input, the at least one ANN can be trained to recognize which teeth are present in the input.

The method can use a single ANN or a plurality of ANNs and the computing device can be configured to execute a single ANN or it could be configured to parallely execute a plurality of ANNs. If a plurality of ANNs is used by the method or configured in the system, in some embodiments, for each tooth or teeth present in a human dentition, at least one ANN can be trained to recognize that tooth or teeth and to create the virtual model of a bonding part of an orthodontic appliance based on the virtual tooth model of that tooth or teeth. As each of the ANNs works solely on the virtual tooth model, operation of the method and system can be faster which shortens the time necessary to create a plurality of virtual models of at least a part of the orthodontic appliance.

In some embodiments of the method and system the orthodontic the orthodontic appliance is in the form of an aligner and/or a retainer, preferably at least one of the group comprising: fixed lingual retainer, fixed labial retainer, removable lingual retainer and removable labial retainer.

In some embodiments of the method and system a 3D-model on basis of the virtual tooth model is manufactured by at least one of the group comprising: additive manufacturing, removal of material of a blank and casting, whereby it is particularly preferred that at least a part of the orthodontic appliance is manufactured by deep drawing or casting by means of the 3D-model.

In some embodiments of the method and system based on at least two virtual models of at least a part of the orthodontic appliance a virtual model of a complete orthodontic appliance is created (by the system). For example, an aligner can be assembled virtually by two parts of the aligner or a retainer can be assembled virtually by a part corresponding to one or a plurality of bonding surfaces and a part corresponding to a—if applicable by a template having a pre-defined shape for instance—connection part of the retainer.

The embodiments with respect to the method and the system are applicable to any part of the dentition in which at least two teeth are at least partially covered by the virtual tooth model. A virtual model of the complete orthodontic appliance and/or of parts of the orthodontic appliance can be composed for example iteratively by a plurality of virtual models of a part of the orthodontic appliance. It is preferably provided that each virtual model of a part of the orthodontic appliance (that can be connected by the artificial neuronal network to form a virtual model of the complete orthodontic appliance) and/or each virtual tooth model (that can be connected by the artificial neuronal network) is created and/or processed in parallel by a neuronal network system. Each virtual model and/or virtual tooth model can e.g. be processed by an individual neuronal network—which is particularly preferred tuned to a specific task or is able to coordinate distinct virtual model tasks in parallel on its own.

In some embodiments with respect to the method and the system based on at least two virtual models of at least a part of the orthodontic appliance a virtual model of a complete orthodontic appliance is created.

In some embodiments it is preferred that a plurality of artificial neuronal networks which work in parallel is used to create the virtual model of at least the part of the orthodontic appliance, in particular virtual models of different parts of the orthodontic appliance. It is for example conceivable to that a specific artificial neuronal network is responsible for a specific virtual model (corresponding to bonding and/or attaching surfaces of certain teeth for instance) in a plurality of virtual models which build up the virtual model of the complete orthodontic appliance.

In some embodiments of the method and system the virtual tooth model of a patient's tooth is provided in the form of a scan file, preferably obtained by tomography, an intraoral scan or scanning a dental imprint. In general, images and/or x-rays of a dentition can be used as well to create the virtual tooth model by the artificial neuronal network.

In these embodiments of the method and system the scan file can be provided in the form of at least one CAD file, preferably at least one STL file or at least one object file, and wherein the at least one artificial neuronal network is trained to read the at least one CAD file.

In some embodiments of the method and system the virtual model of at least the part of the orthodontic appliance is provided in the form of at least one CAD file, preferably at least one STL file or at least one object file.

In some embodiments of the process for manufacturing at least a part of the orthodontic appliance or a complete orthodontic appliance by using a virtual model of at least a part of the ortodontic appliance created by a method according to one of the embodiments described above or by a system according to one of the embodiments described above, the part of the orthodontic appliance or the complete orthodontic appliance is manufactured by at least one of the group comprising: additive manufacturing, deep drawing and removal of material of a blank, whereby it is particularly preferred provided that at least one strut is connected to at least the part of the orthodontic appliance during the manufacturing process.

In some embodiments of the device it is provided that the device is built as a one-piece device (including the orthodontic appliance and materially integrated connected strut(s) in general).

In some embodiments of the device the orthodontic appliance is in the form of an aligner and/or a retainer, preferably at least one of the group comprising: fixed lingual retainer, fixed labial retainer, removable lingual retainer and removable labial retainer.

In some embodiments of the device the at least one strut connects at least two different and spatially separated areas of the orthodontic appliance and/or connects at least one area of the orthodontic appliance with a different strut.

The device and/or the orthodontic appliance or any part thereof can be formed of ceramic, composite, plastic or metal and is preferably translucent, opaque or fully transparent (e.g., aluminium oxide or zirconium oxide ceramics).

Training of the at least one artificial neuronal network:

Training of the system (training of the method can be thought of analogously) can be done as is known in the art regarding ANNs, e.g., using supervised training.

The supervised training can be done in the usual way by providing training data, comparing the created output with a target output and adapting the ANNs to better approximate the target output by the created output, e.g., with back-propagation, until a desired degree of accuracy is reached. This is usually done before inference operation of the system. As is known in the art, supervised training can encompass, e.g., supervised learning based on a known outcome where a model is using a labeled set of training data and a known outcome variable or reinforcement learning (reward system).

In order to train an ANN to recognize a virtual tooth model, in particular different shapes of labial surfaces of teeth that might be present in a dentition of a patient, provided for example in the form of at least one CAD file, during supervised training, training data can be provided to the system, comprising:
3D-representations of teeth of a human dentition; for each tooth a plurality of different possible shapes in different orientations is given, preferably examples having different possible scan defects and/or colors are also given preferably 3D-representations showing different (parts of) dentitions, i.e., showing which teeth are adjacent to another are given, preferably (parts of) dentitions having gaps due to missing teeth are also given

Once an ANN has been trained to recognize a shape of a labial surface and/or a lingual surface of a tooth or a dental arch with adjacent teeth it is easy for the ANN to create a matching bonding surface of the lingual part and/or the labial part because the shape of a matching bonding surface and/or attaching surface is simply the negative shape of the labial surface and/or the lingual surface of the tooth or rather the teeth of interest (in general it is possible to neglect an individual tooth and focus on the geometry of a plurality of adjacent teeth, whereby it is possible as well to combine at least two individual teeth in a connection procedure) in the dental arch where at least the part of the orthodontic appliance is intended to be bonded to. A structure of a part of the orthodontic appliance or rather the complete orthodontic appliance other than the bonding surface can—if applicable—have the same shape and can, e.g., be loaded from a database (as a connecting area of a retainer or an outer surface of an aligner for instance).

The same logic can be used in order to train an ANN to be able to automatically create a model of a complete orthodontic bracket based on at least two virtual models of at least a part of the orthodontic appliance (pre-defined parts can be stored, e.g., in a database): The ANN can be provided with files showing different parts of the orthodontic appliance as well as files showing complete orthodontic appliances and can then, in a supervised way, be taught to combine virtual models of parts of the orthodontic appliance to obtain a complete orthodontic appliance—in particular based on (a part of) a virtual tooth model with a given bonding area and/or attaching area. If a part of the orthodontic appliance—represented by a virtual model of a part of the orthodontic appliance—can be pre-defined and/or is independent of the bonding area and/or attaching area of the tooth model, this virtual mode could be done by an algorithm, devised by a human programmer, which accepts as input a virtual model of a pre-defined part of the orthodontic appliance and a virtual model of a part of the orthodontic appliance (generated on basis of the geometry of the virtual tooth model and in general consider at least two teeth of the virtual tooth model) and outputs a virtual model of the combined virtual models, i.e., a virtual model of a complete orthodontic appliance consisting of these two parts of the orthodontic appliance.

Supervised training can be stopped once a desired accuracy is achieved by the system.

### BRIEF DESCRIPTION OF DRAWINGS

The Figures show schematic views of:

FIG. 1: a system according to an embodiment of the invention

FIG. 2: a method according to an embodiment of the invention

FIGS. 3a and 3b: a first orthodontic appliance in the form of a lingual retainer manufactured by a process according to an embodiment of the invention on a plurality of teeth of a mandible of a patient's dentition and a second orthodontic appliance in the form of a lingual retainer manufactured by a process according to an embodiment of the invention—for example for bonding to a maxilla of a patient's dentition

FIG. 4a: an embodiment of a virtual model in the form of an STL file of an orthodontic appliance in the form of an aligner according to an embodiment of the invention

FIGS. 4b and 4c: an embodiment of a virtual model in the form of a CAD file of an orthodontic appliance in the form of an aligner according to an embodiment of the invention in a perspective top view and in a perspective bottom view

FIG. 5: an orthodontic appliance with struts

FIG. 6: an orthodontic appliance with a single strut

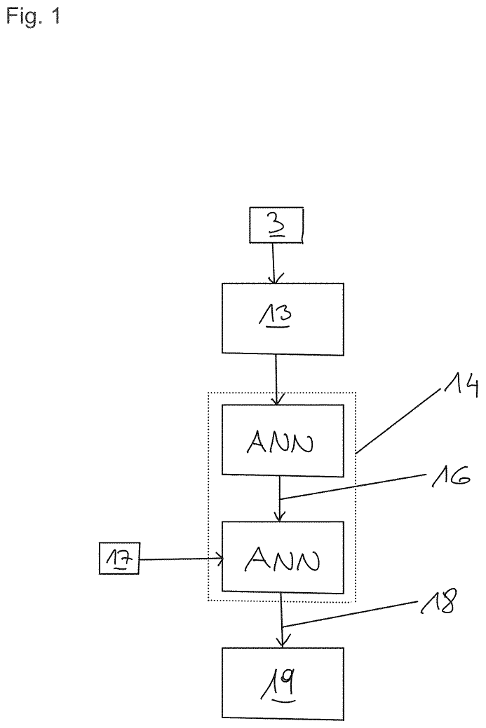

FIG. 1 shows a system and the steps of a method according to a first embodiment of the invention.

The system comprises at least one input 13 which is configured to receive a virtual tooth model, e.g., in the form of at least one CAD file. An artificial neuronal network can accept the CAD file or create its own virtual tooth model e.g. by machine laming and/or deep learning. The input 13 is connected to a computing device 14 which, in this embodiment is configured to execute in parallel (i.e., at the same time) at least two ANNs arranged sequentially (i.e., the ANN shown at a lower position in FIG. 1 receives information from the ANN shown at a higher position in FIG. 1). The first ANN is trained to create a virtual model 16 of a first part of an orthodontic appliance (or the complete orthodontic appliance) and to provide this virtual model 16 of the first part of the orthodontic appliance to the sequentially arranged ANN. This ANN receives as input (e.g., via another input 13—not shown—or the input 13 shown in the top of the figure) a virtual model 17 of a second part of the orthodontic appliance and is trained to create, based on the virtual model 16 of the first part and the virtual model 17 of the second part, a virtual model 18 of a complete orthodontic appliance which can be made available via at least one output 19 of the system, e.g., in the form of a CAD file. The virtual model 18 of the complete orthodontic appliance can either be directly provided to a manufacturing device to manufacture a physical embodiment of the complete orthodontic appliance or can be modified by a human operator using one of the computer programs known in the art and then be provided to a manufacturing device to manufacture a physical embodiment of the complete orthodontic appliance. In general, it is conceivable as well that the artificial neuronal network initiates an output of the virtual tooth model or a part of the virtual tooth model to a manufacturing device—for example to manufacture a 3D-model of the virtual tooth model which can be used to produce the orthodontic appliance.

The virtual model 17 of the second part of the orthodontic appliance can already incorporate the virtual model 16 of the first part of the orthodontic appliance (which can already lead to the virtual model 18 of the complete orthodontic appliance) or alternatively is independent of the virtual model 16 of the first part of the orthodontic appliance, whereby in the latter case the two virtual models 16, 17 of the individual parts of the orthodontic appliance can be combined to the virtual model 18 of the complete orthodontic appliance in a further procedural step by means of the artificial neuronal network.

The system shown in FIG. 1 could have a computing device 14 which, in this embodiment is configured to execute in parallel (i.e., at the same time) at least two ANNs arranged sequentially wherein the upper ANN in FIG. 1 is trained to create virtual models 16 of bonding surfaces 5 of retainers and/or attaching surfaces 5 of aligners in parallel when provided with a virtual tooth model 3 showing a plurality of teeth (at least a part of at least two teeth); and the lower ANN in FIG. 1 is trained to create virtual models 18 of complete orthodontic appliances when provided with virtual models 16, 17 of a part of the orthodontic appliance.

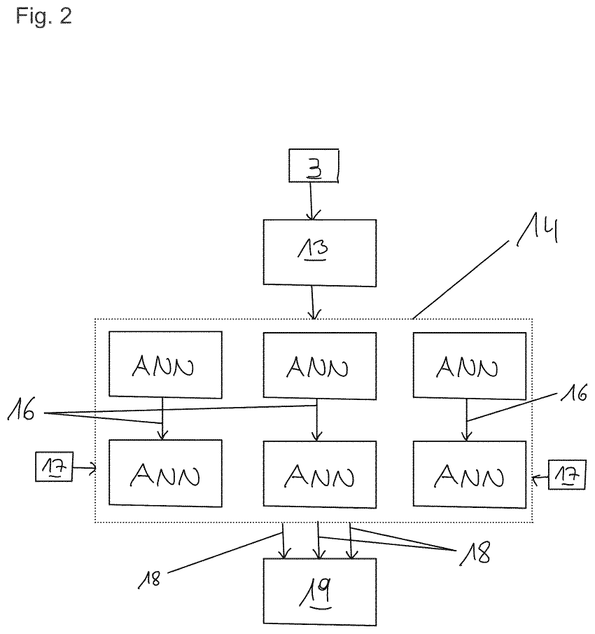

FIG. 2 shows a system and the steps of a method according to a second embodiment of the invention.

The only difference between the first embodiment shown in FIG. 1 and the second embodiment shown in FIG. 2 consists in the variation that in the second embodiment the computing device 14 is configured to execute in parallel (i.e., at the same time) a plurality of ANNs both, with respect to the upper position in FIG. 2 and with respect to the lower position.

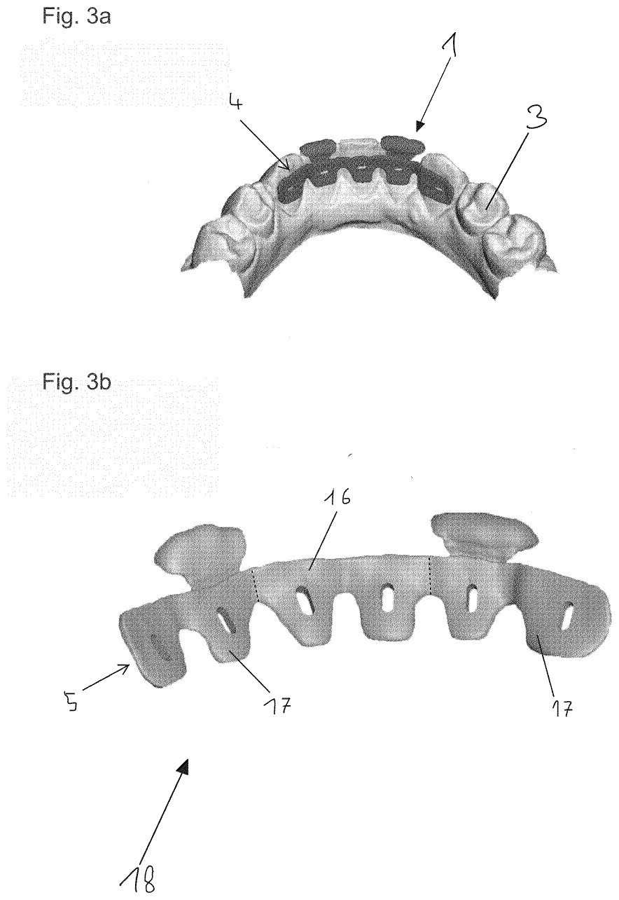

FIG. 3a shows a virtual tooth model 3 to which a virtual model 1 of the orthodontic appliance in the form of a retainer is bonded digitally. The virtual tooth model 3 models a part of the mandible, whereby the artificial neuronal network determined the bonding area 4 of a labial surface of the virtual tooth model 3 to which the orthodontic appliance is bonded. Dependent on the bonding area 4, the virtual model 1 of the orthodontic appliance is created by the artificial neuronal network, wherein the bonding surface 5 of the virtual model 1 of the orthodontic appliance (in general the individual virtual models 16, 17 which constitute the virtual model 18 of the complete orthodontic appliance) corresponds to the virtual tooth model 1 in a way that the geometry of the relevant teeth with respect to the orthodontic appliance is considered.

FIG. 3b shows a virtual model 18 of the complete orthodontic appliance that is composed by two virtual models 16, 17. The number of underlying virtual models 16, 17 is in general arbitrary and can depend e.g. on the amount of artificial neuronal networks which are capable of identifying various substructures of the virtual tooth model 3 and/or virtual models 16, 17 of a part of the orthodontic appliance.

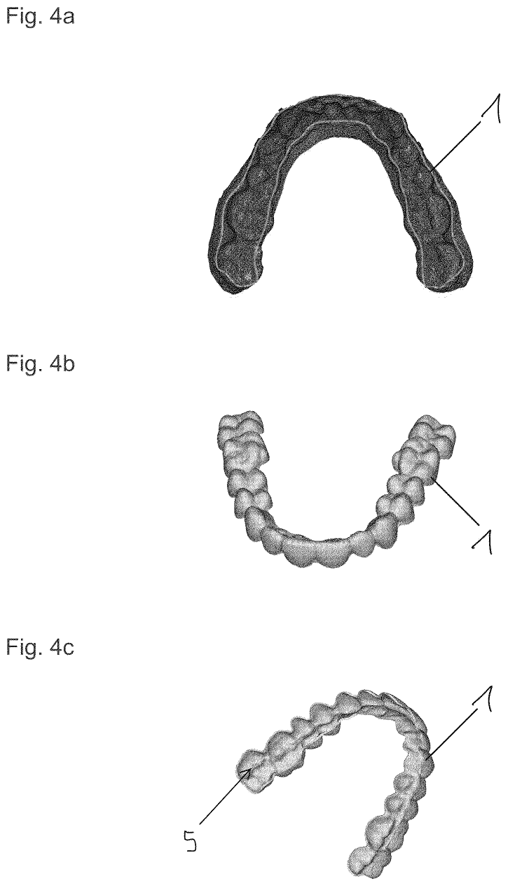

FIG. 4a shows a virtual model 18 of the complete orthodontic appliance in the form of an aligner which can be used to fabricate the aligner directly (via various manufacturing processes like 3D-printing) in a dentist's office for instance.

The embodiment of FIG. 4b differs from the one of FIG. 4a only in that in this embodiment the virtual model 1 of the orthodontic appliance is in the form of a CAD file. After manufacturing the aligner, the aligner can be attached to a patient's dentition with a highly accurate fit due to the fact that the attaching surface 5 of the virtual model 1 is generated by use of the attaching area 4 of the virtual tooth model 3 with regard to curvature and other geometrical properties.

The embodiment of FIG. 4c differs from the one of FIG. 4b only in a different angle of perspective, whereby it can be seen that the attaching surface 5 comprises a geometry that reflects the geometry of the corresponding teeth which is modeled by a virtual tooth model 3 (that can be in general a virtual tooth model 3 of the complete dental arch or of at least a part of the dental arch—in particular at least a part of at least two teeth or composed by two virtual tooth models 3 in each case of at least a part of a single tooth).

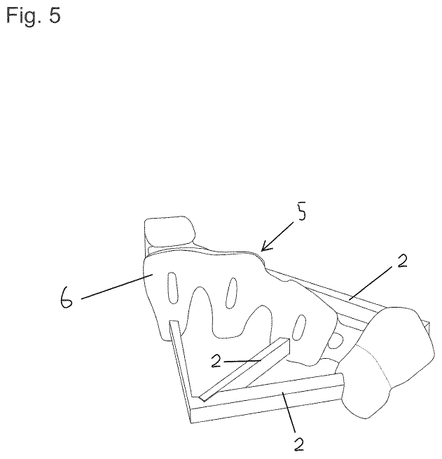

FIG. 5 shows a device comprising an orthodontic appliance 6 in the form of a retainer and a plurality of struts 2 which are manufactured by 3D-printing. Milling or other manufacturing processes for example are possible as well to produce the orthodontic appliance 6 based on the virtual model 1. Struts 2 are connected to the orthodontic appliance 6 during the manufacturing process to stabilize the structure. After finishing the manufacturing process, all the struts 2 can be removed to treat a patient's dentition with the retainer. It is possible as well to remove merely some of the struts 2 and use the remaining strut (s) 2 as a assistance for bonding the orthodontic appliance 6 to the dental arch of the patient for treating an orthodontic condition. If applicable, all the struts 2 can remain on the device till the orthodontic appliance 6 is attached to the patient's dentition and afterwards the struts 2 are removed. The intermediate strut 2 connects an intermediate area of the retainer with a strut 2 that connects bordering areas of the retainer.

The form and the number of connecting points of the struts 2 are in general arbitrary. The struts 2 are not restricted to the manufacturing and/or bonding process of retainers, whereby struts 2 can be for example analogously used for aligners to stabilize the constructional design of the aligner during manufacturing. The struts 2 can be used in an interior surface and/or on an outer surface of the aligner.

The struts 2 can be connected to the virtual model 1 of the orthodontic appliance by the artificial neuronal network—e.g. by a template or machine learning. A human operator can connect the struts 2 to the virtual model 1 by hand as well to include the struts 2 in the additive (or other) manufacturing process of the orthodontic appliance 6 and in particular of the device with the orthodontic appliance 6 and the struts 2. Locations for connection points with respect to the struts 2 can be pre-defined, defined by hand (in a CAD software on basis of the virtual model 1 for instance) or automatically defined (by the ANN or an algorithmus depending on the virtual model 1).

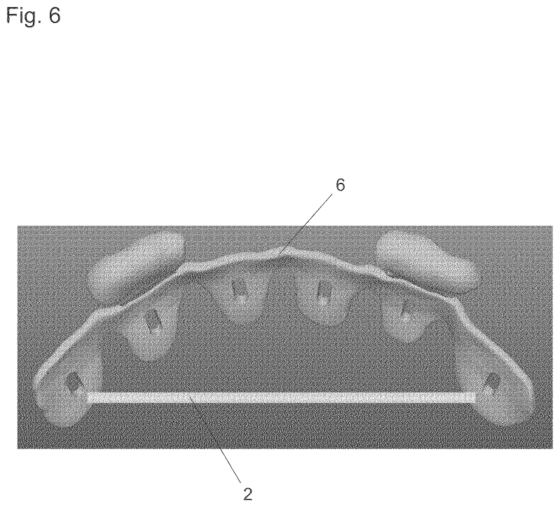

FIG. 6 shows an orthodontic appliance 6 with a single strut 2 which acts as a mechanical strengthening structure during the manufacturing process as well as a handling bar for a more comfortable attachment onto the dentition. The strut 2 can in general exhibit solely one of these functions as well. The amount of struts 2 is in general arbitrary.

### REFERENCE SIGNS LIST

1 virtual model
2 strut
3 virtual tooth model
4 bonding area and/or attaching area of virtual tooth model
5 bonding surface and/or bonding surface of orthodontic appliance
6 orthodontic appliance
13 input of system
14 computing device
16 virtual model of first part of orthodontic appliance
17 virtual model of second part of orthodontic appliance
18 virtual model of complete orthodontic appliance
19 output of system

1. A computer-implemented method for creating a virtual model (1) of at least a part of an orthodontic appliance, comprising at least the following steps:
providing a virtual tooth model (3) representing at least a lingual part and/or a labial part of a mandible and/or maxilla of a dentition of a patient, the virtual tooth model (3) modeling at least a labial surface and/or a lingual surface of the patient's teeth to which the orthodontic appliance is to be bonded and/or attached
accepting, as input, a bonding area and/or and attaching area (4) of the labial surface and/or the lingual surface of the virtual tooth model (3) to which the orthodontic appliance is to be bonded and/or attached or, determining a bonding area and/or an attaching area (4) of the labial surface and/or the lingual surface of the virtual tooth model (3) to which the orthodontic appliance is to be bonded and/or attached
using at least one artificial neuronal network to create, on basis of said bonding area and/or attaching area (4) of the virtual tooth model (3), at least the virtual model (1) of at least the part of the orthodontic appliance, the virtual model (1) of at least the part of the orthodontic appliance having a bonding surface and/or attaching surface (5) which is modeled in such a way that said bonding surface and/or attaching surface (5) matches the bonding area and/or attaching area (4) of the virtual tooth model (3).

2. The method of claim 1 wherein the orthodontic appliance is in the form of an aligner and/or a retainer.

3. The method of claim 1, wherein a 3D-model on basis of the virtual tooth model (3) is manufactured by at least one of the group comprising: additive manufacturing, removal of material of a blank and casting.

4. The method of claim 1, wherein based on at least two virtual models (1) of at least a part of the orthodontic appliance a virtual model of a complete orthodontic appliance (18) is created.

5. The method of claim 1, wherein a plurality of artificial neuronal networks which work in parallel is used to create the virtual model (1) of at least the part of the orthodontic appliance, in particular virtual models of different parts of the orthodontic appliance (17, 18).

6. The method of claim 1, wherein the virtual tooth model (3) of a patient's tooth is provided in the form of a scan file.

7. The method of claim 1, wherein the scan file is provided in the form of at least one CAD file, and wherein the at least one artificial neuronal network is trained to read the at least one CAD file.

8. The method of claim 1, wherein the virtual model (1) of at least the part of the orthodontic appliance is provided in the form of at least one CAD file.

9. A system for creating a virtual model (1) of at least a part of an orthodontic appliance, comprising at least:
at least one input (13) configured to receive a virtual tooth model (3) representing at least a lingual part and/or a labial part of a mandible and/or maxilla of a dentition of a patient, the virtual tooth model (3) modeling at least a labial surface and/or a lingual surface of the patient's teeth to which the orthodontic appliance is to be bonded and/or attached
at least one computing device (14) which is configured to execute at least one artificial neuronal network which is trained to
accept, as input (13), a bonding area and/or and attaching area (4) of the labial surface and/or the lingual surface of the virtual tooth model (3) to which the orthodontic appliance is to be bonded and/or attached or, determine a bonding area and/or an attaching area (4) of the labial surface and/or the lingual surface of the virtual tooth model (3) to which the orthodontic appliance is to be bonded and/or attached
create, on basis of said bonding area and/or attaching area (4) of the virtual tooth model (3), the virtual model (1) of at least the part of the orthodontic appliance, the virtual model (1) of at least the part of the orthodontic appliance having a bonding surface and/or attaching surface (5) which is modeled in such a way that said bonding surface and/or attaching surface (5) matches the bonding area and/or attaching area (4) of the virtual tooth model (3).

10. The system of claim 9, wherein the orthodontic appliance is in the form of an aligner and/or a retainer.

11. The system of claim 9, wherein the at least one computing device (14) is configured to instruct a manufacturing device to manufacture a 3D-model on basis of the virtual tooth model (3) by at least one of the group comprising: additive manufacturing, removal of material of a blank and casting.

12. The system of claim 9, wherein based on at least two virtual models (1) of at least a part of the orthodontic appliance a virtual model of a complete orthodontic appliance (18) is created.

13. The system of claim 9, wherein a plurality of artificial neuronal networks which work in parallel is used to create the virtual model (1) of at least the part of the orthodontic appliance, in particular virtual models of different parts of the orthodontic appliance (16, 17).

14. The system of claim 9, wherein the at least one input (13) is configured to receive the virtual tooth model (3) of a patient's tooth in the form of a scan file.

15. The system of claim 14 wherein the at least one input (13) is configured to receive the scan file in the form of at least one CAD file, and wherein the at least one artificial neuronal network is trained to read the at least one CAD file.

16. The system of claim 9, wherein the system is provided with at least one output (19) which is configured to provide the virtual model (1) of at least the part of the orthodontic appliance in the form of at least one CAD file.

17. A process for manufacturing at least a part of an orthodontic appliance by using a virtual model (1) of at least part of an orthodontic appliance created by a method of at least one of claim 1.

18. The process of claim 17 wherein the part of the orthodontic appliance (6) or a complete orthodontic appliance (6) is manufactured by at least one of the group comprising: additive manufacturing, deep drawing and removal of material of a blank.

19. A computer program which, when the program is executed by a computer causes the computer to carry out the method of claim 1.

20. A computer-readable medium comprising instructions which, when executed by a computer, causes the computer to carry out the method of claim 1.

21. A data carrier signal carrying:
at least one virtual model (1) created by a method of claim 1.

22. A device comprising:
an orthodontic appliance (6), in particular manufactured by a process according to claim 17, which is adapted to be bonded or attached to a plurality of teeth and
at least one strut (2)
wherein the at least one strut (2) is connected to at least two different areas of the orthodontic appliance (6).

23. The device of claim 22, wherein the device is built as a one-piece device.

24. The device of claim 22, wherein the orthodontic appliance (6) is in the form of an aligner and/or a retainer.

25. The device of claim 22, wherein the at least one strut (2) connects at least two different and spatially separated areas of the orthodontic appliance (6) and/or connects at least one area of the orthodontic appliance with a different strut (2).
